(19) United States
(12) Patent Application Publication
(10) Pub. No.: US 2010/0141230 A1
(43) Pub. Date: Jun. 10, 2010

(54) SELF-TUNING SENSORLESS DIGITAL CURRENT-MODE CONTROLLER WITH ACCURATE CURRENT SHARING FOR MULTIPHASE DC-DC CONVERTERS

(75) Inventors: Zdravko Lukic, Toronto (CA); S M. Ahsanuzzaman, Toronto (CA); Aleksandar Prodic, Toronto (CA)

Correspondence Address: FLIESLER MEYER LLP, 650 CALIFORNIA STREET, 14TH FLOOR, SAN FRANCISCO, CA, 94108, US

(73) Assignee: EXAR CORPORATION, Fremont, CA (US)

(21) Appl. No.: 12/498,132

(22) Filed: Jul. 6, 2009

Related U.S. Application Data
(60) Provisional application No. 61/081,660, filed on Jul. 17, 2008.

(51) Int. Cl. G05F 1/618

(52) U.S. Cl. 323/283

(57) ABSTRACT

Embodiments of the present invention concern a multiphase switch-mode power supply. The multiple phase switch-mode power supply can have at least one switch and a digital controller to control the switching of the at least one switch. During a calibration period, the digital controller can freeze the current of all of the multiple phases except for a phase being calibrated. This can be done by fixing the current reference of the phases except for the phase being calibrated.

### CLAIM OF PRIORITY

This application claims priority from the following co-pending application, which is hereby incorporated in its entirety: U.S. Provisional Application No. 61/081,660 entitled: “SELF-TUNING SENSORLESS DIGITAL CURRENT-MODE CONTROLLER WITH ACCURATE CURRENT SHARING FOR MULTIPHASE DC-DC CONVERTERS”, by Zdravko Lukic, et al., filed Jul. 17, 2008, (Attorney Docket No.: EXAR-01020U50).

### BACKGROUND OF THE INVENTION

Multiphase DC-DC Switch-Mode Power Supplies (SMPS) are common in modern electronic devices such as personal computers, servers, telecommunication devices and consumer electronics. Compared to traditional single-phase topologies, these parallel structures show several advantages. Those include better heat distribution, faster dynamic response, smaller voltage and current ripple, all of which result in significant reduction of the overall size of the power supply.

One of the main challenges in full utilization of multi-phase converter topologies advantages is to ensure equal current sharing between the phases. Even if all phases are comprised of the same components, mismatches in their actual values can result in serious problems. Some of the phase could take significantly larger current than others and result in current-stress related system failures.

To eliminate the current sharing problem, analog current sensing circuits are commonly employed. They often require costly implementation, which, in some cases, can overweight the advantages of the multi-phase operation. In addition, the analog sensing solutions are often very sensitive to external influences such as temperature and aging and are not suitable for integration with emerging digital systems that show superior performance and flexibility compared to commonly use analog controllers.

### BRIEF DESCRIPTION OF THE DRAWINGS

FIG. 1 shows a Switch-Mode Power Supply (SMPS) of one embodiment of the present invention.

FIG. 2 shows the use of a digital filter IIR to replace an analog filter of one embodiment.

FIG. 3 shows a current sink used for calibration of a multi-phase current estimator.

FIG. 4 shows a simulation result of a calibration step applied to a two phase buck convertor with one control signal unchanged.

FIG. 5 shows an inductor current waveform during two consecutive switching cycles.

FIG. 6 illustrates digital logic to determine a duty ratio value

FIGS. 7-9 are diagrams that illustrate system operation of one embodiment.

### DETAILED DESCRIPTION

One embodiment of the present invention is a novel self-tuning digital current estimator and average current program mode controller for Multi-Phase DC-DC Switch-Mode Power Supplies (SMPS). Based on the information about the output voltage and inherently available duty ratio value, the estimator can calculate the average current of each phase in a multi-phase dc-dc converter topology. The obtained averaged values can be calculated over one switching cycle and used for the implementation of a multi-phase current program mode control loop. To eliminate the estimation error caused by external influences and parameter variations as well as unequal current sharing, a phase-by-phase self calibration scheme can be employed. During the calibration, all current loops but one can be “frozen” and a small load step can be introduced by a test current sink and the estimator response is observed. Based on the response, the estimator parameters and the current program loop can be adjusted such that accurate current measurement and equal current sharing are obtained.

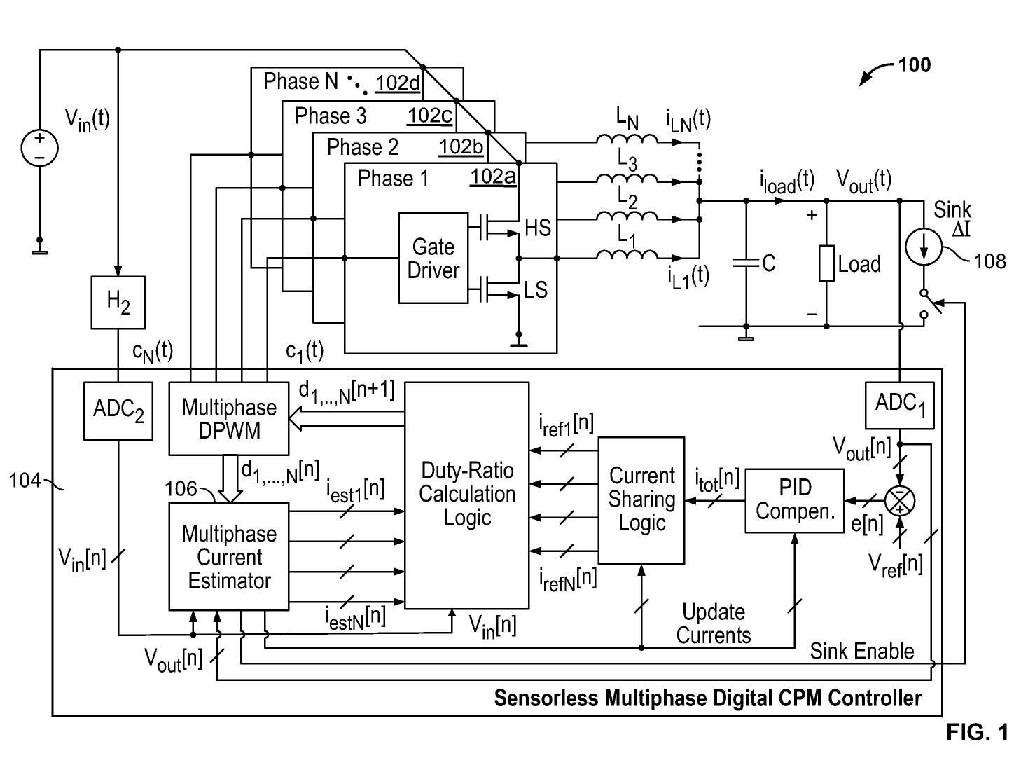

Embodiments of the invention can provide a solution with equal current sharing in multi-phase topologies and is well suited for integration in digital systems. As shown in FIG. 1, the new system can be fully digital. It can comprise a multi-phase current estimator that calculates the current of each phase and an average multi-phase current program mode controller.

One embodiment is a multiphase switch-mode power supply 100 comprising multiple phases 102a, 102b, 102c and 102d having at least one switch and a digital controller 104 to control the switching of the at least one switch of the multiple phases. During a calibration period, the digital controller can freeze the current of all of the multiple phases except for a phase being calibrated.

The freezing of a phase means that it does not change its current during this portion of the calibration. The freezing can comprise fixing the current reference values of all the phases except for the phase being calibrated. Each of the phases can be calibrated in turn.

The digital controller 104 can be a multiphase digital current-mode controller.

The digital controller 104 can use a multiphase current estimator. The multiphase current estimator can estimate a current through a power inductor associated with one of the phases.

The estimate of average voltage across the power inductor can be performed from the values of the regulated output voltage and duty ratio control variable.

The self tuning can use a current sink 108. The current sink 108 can use a switch and resistor positioned across a load of the switched mode power supply.

Calibration logic in the multiphase current estimator can adjust coefficients for the estimation of current through the power inductor based on the response of the estimate current value to the operation of the current sink while all but one of the phases have their current frozen.

A digital filter can be used to derive an estimate of the power inductor current from an estimate of the voltage across the power inductor. Calibration logic can adjust the coefficients of the digital filter. The adjustment can be done as a result of a test current sink.

A deviation in the digital filter output DC value or overshoots and/or undershoots in the filter response can be used in the adjustment.

The digital controller 104 can turn off the switch mode power supply 100 when the estimated current exceeds a threshold value.

A multiphase current estimator can comprise of a digital filter 106 which can produce a current estimate from a voltage based input value. A current sink 108 can produce an increase in the current. Calibration logic can update coefficients for the digital filter based on the current increase produced by the current sink. Current estimation can be done for one of multiple phases. The remaining phases can be frozen while the one of the multiple phases is calibrated.

A switched mode power supply 100 can comprise multiple phases 102a, 102b, 102c and 102d with at least one switch and a power inductor and a digital controller 104 to control the switching of the at least one switch of the switched mode power supply. The current through the power inductor can be estimated using a self-tuning multiphase digital current estimator. The self tuning can use a current sink. During the calibration of one of the phases, the current of the other phases are frozen.

The multi-phase current estimator operates on a similar principle as the fully-digital system described in U.S. Provisional application entitled “SELF-TUNING DIGITAL CURRENT ESTIMATOR FOR LOW-POWER SWITCHING CONVERTERS”, U.S. Ser. No. 61/048,655, filed on Apr. 29, 2008, by Aleksandar Prodić, et al., incorporated herein by reference. The previous estimator was designed to operate with single phase converter topologies. To describe the system operation in an easy to grasp manner, the operation of the single phase estimator is briefly reviewed first and the new multi-phase architecture is described afterwards.

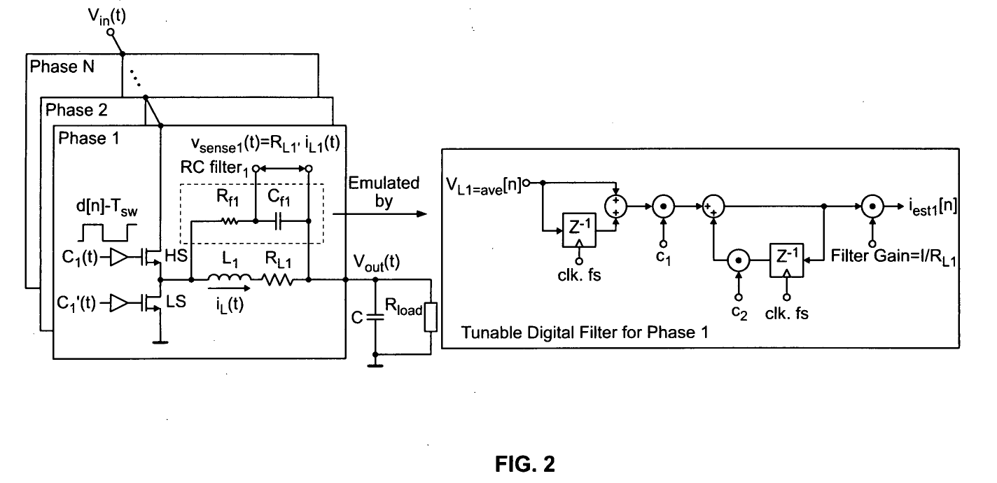

As shown in FIG. 2, the main idea in the single phase estimator implementation is to implement well-known RC current estimation method in a digital manner. The analog RC filter, which provides voltage proportional to the inductor current

$${V}_{sense 1} ( s ) = {I}_{L 1} ( s ) \cdot {R}_{L 1} \cdot \frac{1 + s \cdot \frac{{L}_{1}}{{R}_{L 1}}}{1 + s \cdot {R}_{f 1} {C}_{f 1}} = {I}_{L 1} ( s ) \cdot {R}_{L 1} \cdot \frac{1 + s \cdot {τ}_{L 1}}{1 + s \cdot {τ}_{f 1}} , \qquad ( 1 )$$

where L₁ and R_{L1}/are the inductance and its equivalent series resistance values, respectively, and R_{f1} and C_{f1} the values of the filter components, is replaced with a programmable, i.e. tunable, digital equivalent. If the filters parameters are selected so that time constants are matched τ_{f1}=R_{f1}·C_{f1}=L₁/R_{L1}=τ_{L1}, the capacitor voltage becomes scaled and undistorted version the phase inductor current (the zero and pole cancel each other). If the time constants are not well matched a large estimation error occurs. This problem often prevents the analog implementation to be widely used, since the filter and converter parameters change in time and with operating conditions. The replacement of the analog component with the programmable digital structure allows us to do on-line calibration and compensate for the time constant variations. The digital filter calibration is done with a help of a current sink. It introduces a small and known load step that is compared to the estimator response and, based on the difference, tuning is performed. The tuning actually adjusts the time constant of the digital filter to be equal to that of the power stage.

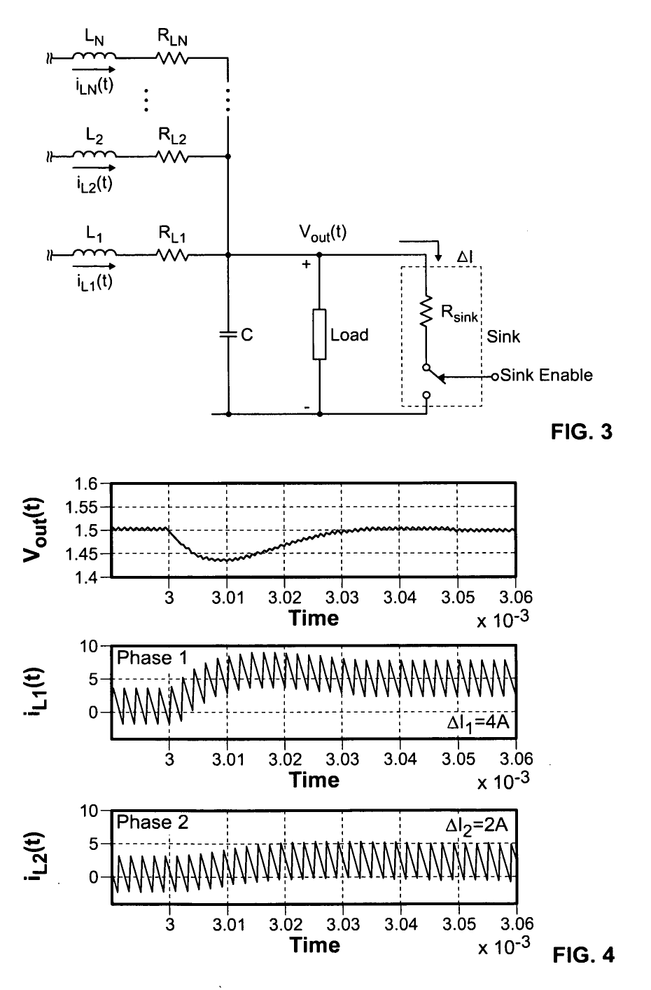

The calibration process used in single phase topologies cannot be directly applied for multi-phase systems. While in the single phase cases, the load step introduced by the current sink must be equal to the inductor current, in multi-phase systems, it is not the case. From FIG. 3 it can be seen that the current step can be shared between the phases in many different ways, depending on the mismatch in component values.

To solve this problem, in one embodiment, a multi-phase average current program mode controller is used and phase-by-phase calibration developed. Prior to the activation of the current sink, the controller freezes the currents of all phases but one keeping them constant during the test phase. As a result only the current in the active phase increases and the increment is equal to that of the test current sink, as shown in the simulation result of FIG. 4. This allows for the active phase calibration.

One embodiment of this invention is shown in FIG. 1. To regulate the output voltage, the controller samples the output voltage vₒᵤₜ(t) and the error signal is processed by the PID compensator, which produces the average current command iₜₒₜ[n] such that in the steady state the value of Iₜₒₜ[n] is equal to i_{load}(t). The current sharing logic takes in iₜₒₜ[n] and generates current references i_{refi}[n], i=1 . . . N according to the desired current distribution between converter phases. For example, if the most common equal current sharing is required, each phase is assigned Iₜₒₜ[n] reference value.

Based on i_{refi}[n] and estimated iₑₛₜᵢ[n], the duty-ratio logic calculates duty ratio value dᵢ[n+1] such that iₑₛₜᵢ[n] follows i_{refi}[n]. The calculated duty-ratio value for each phase is then fed to the multiphase digital pulse-width modulator, which produces appropriate switching signals cᵢ(t), i=1 . . . N.

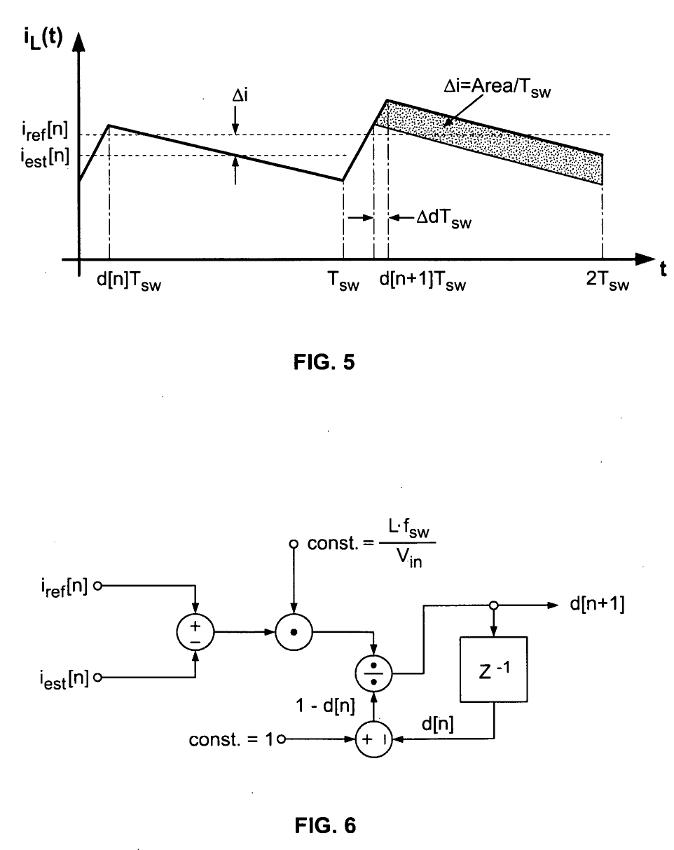

Duty-ratio calculation logic can be designed such that the average value of the inductor phase current follows desired reference i_{refi} while maintaining regulated output voltage. For example, consider the case shown in FIG. 5, where there is an initial difference between the estimated and reference current. In order to match these two, the duty-cycle d[n+1] is increased/decreased by Δd, such that the average value of the inductor current in the next switching cycle is equal to the reference. In that case, the net increase in the average inductor current is proportional to the shaded area shown in FIG. 5. This area can be calculated as:

$$Area = \frac{{V}_{i n}}{L} \cdot Δ d \cdot {T}_{sw} \cdot ( 1 - d [ n ] ) \cdot {T}_{sw} . \qquad ( 2 )$$

Therefore, the average current increment in the next switching cycle is equal to:

$$Δ i = \frac{Area}{{T}_{SW}} = \frac{{V}_{i n}}{L} \cdot Δ d \cdot {T}_{SW} \cdot ( 1 - d [ n ] ) \qquad ( 3 )$$

Based on (2) and (3), the new duty-ratio value d[n+1] is calculated as:

$$d [ n + 1 ] = d [ n ] + Δ d = d [ n ] + \frac{{i}_{ref} [ n ] - {i}_{est} [ n ]}{{V}_{i n} \cdot ( 1 - d [ n ] )} \cdot L \cdot {f}_{sw} \qquad ( 4 )$$

The block diagram of the digital logic that implements (4) is shown in FIG. 6.

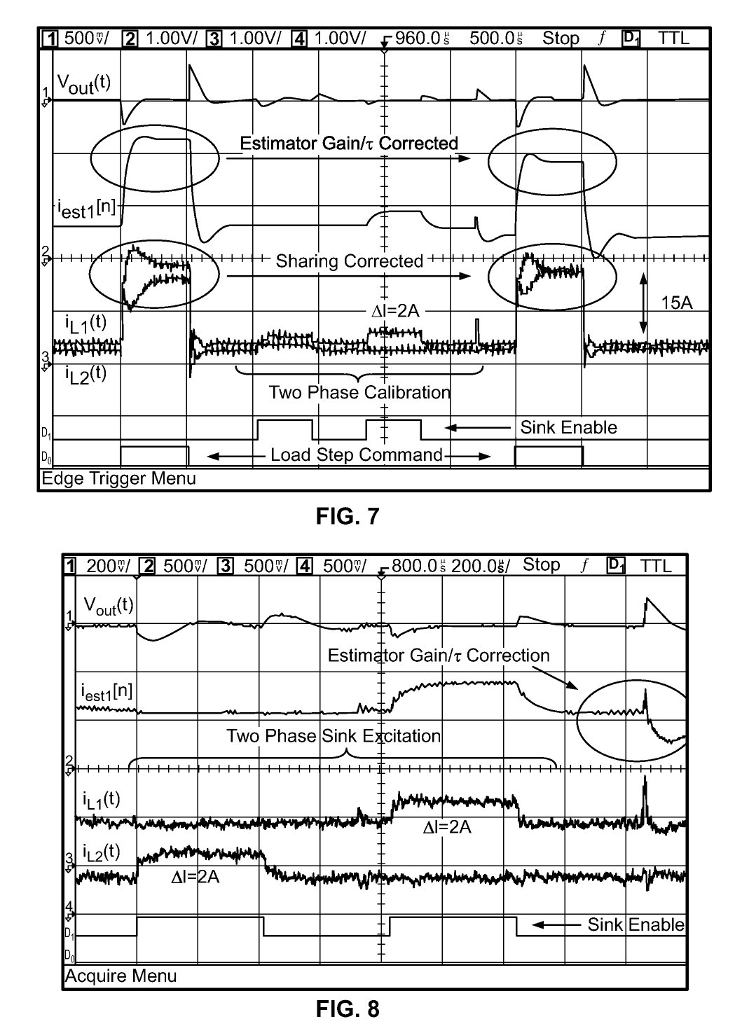

To verify functionality of the controller architecture from FIG. 1, a 12V-to-1.5V two-phase buck converter having 40 A load current capability was built. All digital parts of the controller were implemented using Altera DE2 FPGA board. For output and input voltage measurements two external ADCs sampling at switching frequency f_{sw} and ⅛ of f_{sw}, respectively, were used. To display the operation of the multiphase current estimator, its digital estimated values are sent to a digital-to-analog converter. In FIG. 7, from the response to the first load step (30A), it can be seen that the multiphase current estimator is not calibrated and the current sharing is not achieved. After enabling the current sink twice and applying the calibration procedure, the estimator parameters for both phases are adjusted. As a result, inductor currents in two phases become equally shared after reapplying the second load step of 30A. FIG. 7 shows the system operation—Ch1: Output converter voltage (500 mV/div); Ch2: estimated inductor current iₑₛₜ₁[n]—10 A/V; Ch3 and Ch4: measured inductor current i_{L1}(t) and i_{L1}(t)—10 A/V; D0-D1—load step command and sink enable. Time scale is 500 μs/div.

FIG. 8 shows the magnified operation of the calibration scheme for two phases. This experimental waveform confirms its effectiveness since when the calibration step of 2A is injected in one of the phases; inductor current in the other phase does not get affected. After injecting calibration steps, the gain and time constant of the filters get calibrated to the correct value which is shown by the red circle in FIG. 8. FIG. 8 shows the calibration procedure—Ch1: Output converter voltage (200 mV/div); Ch2: estimated inductor current iₑₛₜ₁[n]—10 A/V; Ch3 and Ch4: measured inductor current i_{L1}(t) and i_{L1}(t)—10 A/V; D0-D1—load step command and sink enable. Time scale is 200 μs/div.

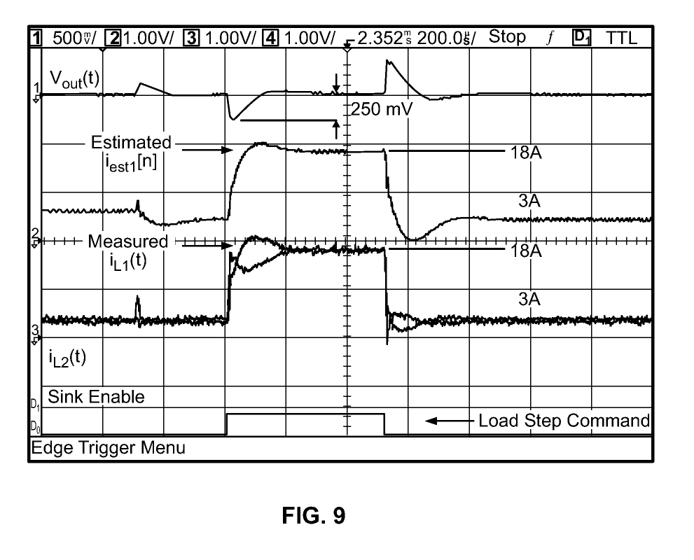

The response of the controller to a load step of 30A with the calibrated current estimator is zoomed in FIG. 9. The figure also shows good matching between measured current iₗ₁(t) and its estimated value iₑₛₜ₁[n]. FIG. 9 shows output converter voltage (200 mV/div); Ch2: estimated inductor current iₑₛₜ₁[n]—10 A/V; Ch3 and Ch4: measured inductor current i_{L1}(t) and i_{L1}(t)—10 A/V; D0-D1—load step command and sink enable. Time scale is 200 μs/div.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A multiphase switch-mode power supply comprising:
multiple phases having at least one switch; and
a digital controller to control the switching of the at least one switch of the multiple phases; wherein during a calibration period, the digital controller freezes the current of all of the multiple phases except for a phase being calibrated.

2. The multiphase switch-mode power supply of claim 1,
wherein the freezing comprises fixing the current reference of the phases except for the phase being calibrated.

3. The switch-mode power supply of claim 1,
wherein the digital controller is a multiphase digital current-mode controller.

4. The switch-mode power supply of claim 1,
wherein the digital controller uses a multiphase current estimator.

5. The switch-mode power supply of claim 4,
wherein the multiphase current estimator estimates a current through a power indicator associated with one of the phases.

6. The switch-mode power supply of claim 5,
wherein the estimate of average voltage across the power inductor is performed from the values of the regulated output voltage and duty ratio control variable.

7. The switched mode power supply of claim 5,
wherein the estimate of the average value of the voltage across the power inductor is performed from the values of the regulated output voltage and duty ratio control variable.

8. The switched mode power supply of claim 1,
wherein the self tuning uses a current sink.

9. The switched mode power supply of claim 8,
wherein the current sink uses a switch and resistor positioned across a load of the switched mode power supply.

10. The switched mode power supply of claim 8,
wherein calibration logic in the multiphase current estimator adjusts coefficients for the estimation of current through the power inductor based on the response of the estimated current value to the operation of the current sink while all but one of the phases have their current frozen.

11. The switched mode power supply of claim 1,
wherein a digital filter is used to derive an estimate of the power inductor current from an estimate of the voltage across the power inductor.

12. The switched mode power supply of claim 11,
wherein calibration logic adjusts the coefficients of the digital filter.

13. The switched mode power supply of claim 11,
wherein the adjustment is done as a result of a test current sink.

14. The switched mode power supply of claim 12,
wherein a deviation in the digital filter output DC value is used in the adjustment.

15. The switched mode power supply of claim 12,
wherein overshoots and/or undershoots in the filter response are used in the adjustment.

16. The switched mode power supply of claim 1,
wherein the digital controller turns off the switched mode power supply when the estimated current exceeds a threshold value.

17. A multiphase current estimator comprising:
a digital filter to produce a current estimate from a voltage based input value;
a current sink to produce an increase in the current; and
calibration logic to update coefficients for the digital filter based on the current increase produced by the current sink; wherein current estimation is done for one of multiple phases; and
wherein the remaining phases are frozen, while the one of the multiple phases is calibrated.

18. The current estimator of claim 17;
wherein the freezing comprises fixing the current reference of the remaining phases.

19. The current estimator of claim 17,
wherein a deviation in the output DC value of the digital filter in response to the current increase is used to determine the update of the coefficients.

20. The current estimator of claim 17,
wherein overshoots and/or undershoots in the digital filter response to the current increase are used to determine the update of the coefficients.

21. The current estimator of claim 17,
wherein the current sink comprises a switch and a resistor.

22. A switched mode power supply using the current estimator of claim 17.

23. A switched mode power supply comprising:
multiple phases with at least one switch and a power inductor; and
a digital controller to control the switching of the at least one switch of the switched mode power supply; wherein the current through the power inductor are estimated using a self-tuning multiphase digital current estimator; and wherein the self tuning uses a current sink; and
wherein there are multiple phases and during the calibration of one of the phases the current of the other phases are frozen.

24. The switched mode power supply of claim 23,
wherein the freezing comprises fixing the current reference of the remaining phases.

25. The switched mode power supply of claim 23,
wherein the current sink uses a switch and resistor positioned across a load of the switched mode power supply.

26. The switched mode power supply of claim 23,
wherein calibration logic in the self tuning digital current estimator adjusts coefficients for the estimation of current through the power inductor based on the response of the estimated current value to the operation of the current sink.
